(19) United States
(12) Patent Application Publication
(10) Pub. No.: US 2018/0187624 A1
(43) Pub. Date: Jul. 5, 2018

(54) Method For Control Of A Ball Planetary Type Continuously Variable Transmission During Engine Braking

(71) Applicant: Dana Limited, Maumee, OH (US)

(72) Inventors: Jeffrey M. David, Cedar Park, TX (US); T. Neil McLemore, Georgetown, TX (US); Matthew Simister, Austin, TX (US)

(21) Appl. No.: 15/849,858

(22) Filed: Dec. 21, 2017

Related U.S. Application Data
(60) Provisional application No. 62/441,751, filed on Jan. 3, 2017.

(51) Int. Cl. F02D 41/26; F02D 41/02; B60W 10/06

(52) U.S. Cl. CPC F02D 41/26; F02D 2250/18; B60W 10/06; F02D 41/0215

(57) ABSTRACT

Provided herein is a method and control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The transmission control module includes a CVP control module. In some embodiments, the transmission control module is adapted to include an engine braking control process. The engine braking control process is configured to adjust the variator corresponding to an engine braking request.

### RELATED APPLICATION

The present application claims the benefit of U.S. Provisional Application No. 62/441,751 filed on Jan. 3, 2017, which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations may for example, multiply input torque across the different transmission stages in different manners to achieve the same final drive ratio. However, some configurations provide more flexibility or better efficiency than other configurations providing the same final drive ratio.

Engine braking occurs when retarding forces within an engine are used to slow a vehicle down. Typically, engine braking conditions correspond to negative engine output torque and indicates that internal engine frictional and pumping losses exceed the available work output of the engine. As an illustrative example, a typical engine braking torque map is depicted in FIG. 5, where engine braking torque is plotted as a function of engine speed and accelerator pedal position. In some cases, negative torque can still occur at driver requests significantly above zero accelerator pedal position signal, provided that the engine speed is sufficiently high

### SUMMARY

Provided herein is a control system and method that uses the negative torque due to engine braking to decelerate the vehicle. When combined with control of a continuously variable transmission, the negative torque can form the basis for an active vehicle control method.

Provided herein is a method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method including the steps of: receiving a plurality of input signals indicative of a PRNDL gear position, n vehicle speed, and a CVP speed ratio; evaluating an engine braking condition based on the PRNDL gear position; determining an engine braking request based on the vehicle speed; comparing the engine braking request to an engine braking threshold; determining a CVP speed ratio setpoint based on the comparison of the engine braking request to the engine braking threshold; and issuing a commanded CVP speed ratio to impart a change in the operating condition of the CVP.

Provided herein is a method for controlling a continuously variable transmission having a ball-planetary variator (CVP) provided with a ball in contact with a first traction ring assembly, a second traction ring assembly, and an idler assembly including the steps of: receiving a plurality of input signals indicative of a grade, a vehicle speed, and a CVP speed ratio; evaluating an engine braking condition based on the grade; determining an engine braking request based on the vehicle speed; comparing the engine braking request to an engine braking threshold; determining a CVP speed ratio setpoint based on the comparison of the engine braking request to the engine braking threshold; and issuing a commanded CVP speed ratio to impart a change in the operating condition of the CVP.

Provided herein is a method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method including the steps of: receiving a plurality of input signals indicative of a vehicle speed, and a CVP speed ratio; evaluating an engine braking condition based on the vehicle speed; determining an engine braking request based on the vehicle speed; comparing the engine braking request to an engine braking threshold; determining a CVP speed ratio setpoint based on the comparison of the engine braking request to the engine braking threshold; and issuing a commanded CVP speed ratio to impart a change in the operating condition of the CVP.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system implementable in a vehicle.

FIG. 5 is a chart depicting an engine braking torque map as a function of engine speed and accelerator pedal position sensor signal.

FIG. 6 is a graph depicting an engine braking request versus vehicle speed.

FIG. 7 is a graph depicting an engine braking request versus road grade.

FIG. 8 is a graph depicting an acceleration versus an estimated grade.

FIG. 9 is a flow chart of an engine braking control process implementable in the vehicle control system of FIG. 4.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, accelerator pedal position sensor values, vehicle speed, gear selector position, user-selectable mode configurations, and the like, or some combination thereof. The electronic controller can also receive one or more control inputs. The electronic controller can determine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

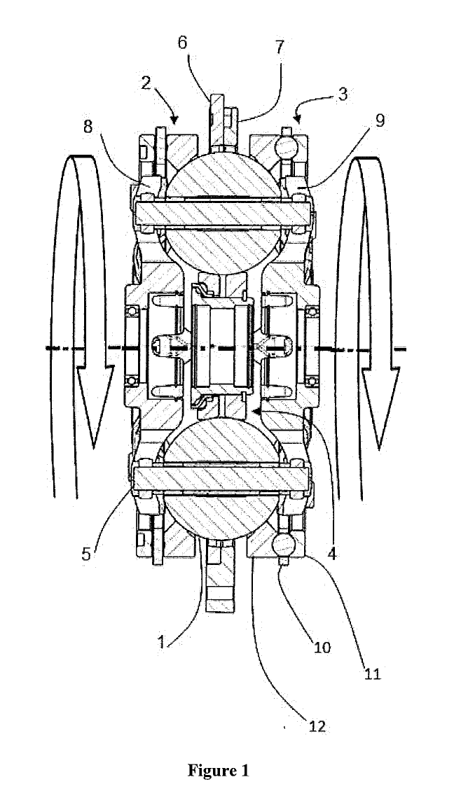

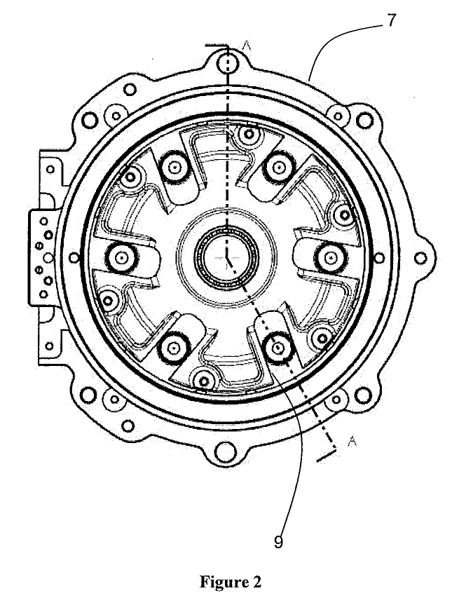

Provided herein are configurations of CVTs based on a ball type variator, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) traction ring assembly 2 and output (second) traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

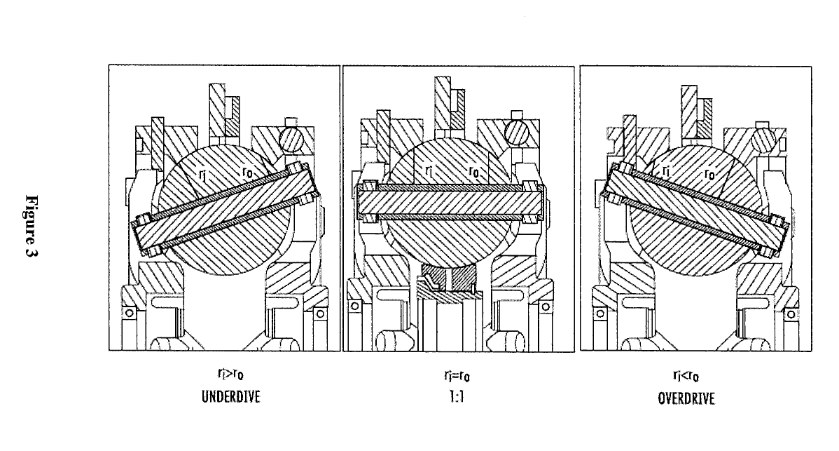

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction.” Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here can operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ, decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, can be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present embodiments. For example, various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Software associated with such modules can reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium can be integral to the processor. The processor and the storage medium can reside in an ASIC. For example, in one embodiment, a controller for use of control of the CVT includes a processor (not shown).

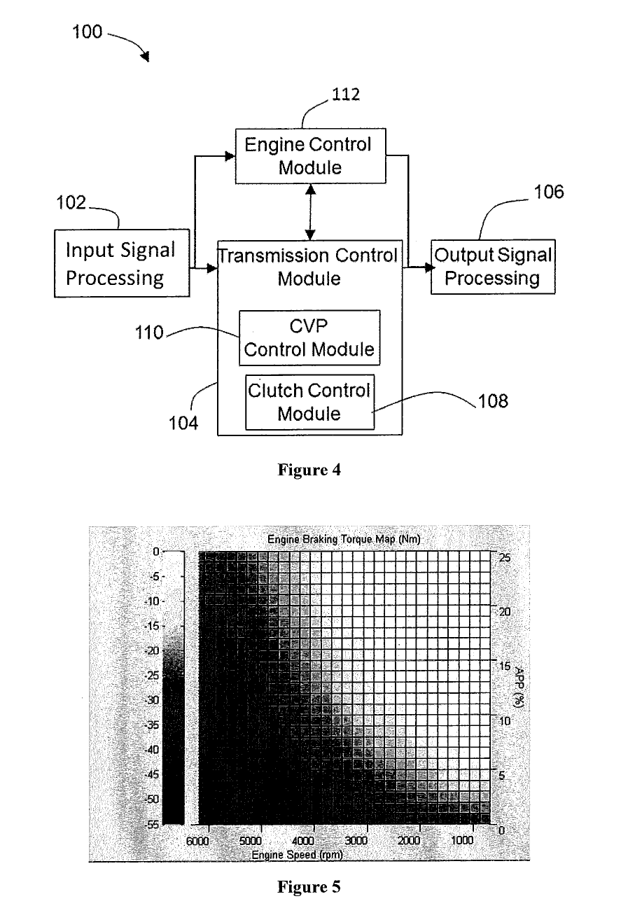

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104. In some embodiments, the engine control module 112 is configured to manage cylinder deactivation of an engine equipped in the vehicle. Cylinder deactivation is used to reduce fuel consumption and emissions of an ICE during light-load operation. In typical light-load driving the driver uses around 30% or less of the engine's maximum power. By selectively shutting down cylinders of the ICE, fuel consumption can be reduced. However, there are limitations on operating engine operating conditions where deactivation of cylinders is avoided due to noise-vehicle-harshness (NVH) considerations. It is desirable to expand the engine operating conditions where cylinder deactivation can be used.

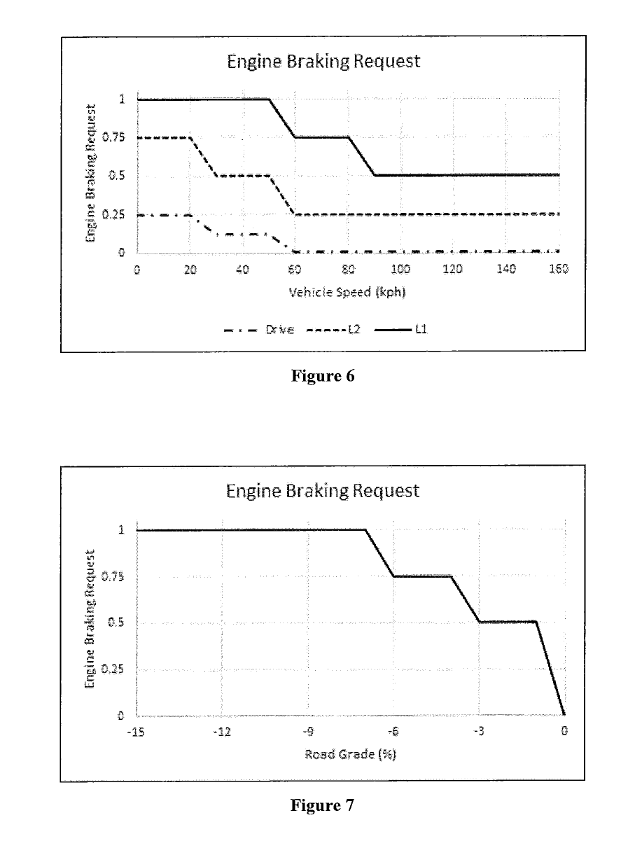

Referring now to FIGS. 5 and 6, in some embodiments, the transmission control module 104 is configured to implement an engine braking control process based on input from a standard gear shifting, sometimes referred to herein as a “PRNDL” sensor. A driver selectable deceleration control mode is entered when the PRNDL sensor detects a shift to a Low range, indicating that the driver has requested additional engine braking. The Low range may consist of one or more shift lever gates that progressively request increasing levels of engine braking. Methods to accomplish the increased braking torque are the following:
Close engine throttle servo (if not already fully closed)
Ratio CVP towards underdrive
Shift range box to a lower gear

The available vehicle deceleration axle torque can be significantly altered through CVP ratio change or by downshifting the range box as shown in the equation below, where “Torque_deceleration” is the deceleration torque of the vehicle, “Torque_engine” is the torque supplied by the engine, “STR” is the torque converter ratio, “Ratio_gearbox” is the ratio of the fixed ratio multiple speed gearbox coupled to the CVP, “Ratio_final_drive” is the ratio of the final drive gear of the vehicle, and “SR_CVP” is the speed ratio of the ball-type continuously variable transmission.

$${Torque}_{deceleration} = \frac{{Torque}_{engine} * STR * {Ratio}_{gearbox} * {Ratio}_{final \_ drive}}{{SR}_{CVP}}$$

A ratio change towards underdrive has a twofold effect on deceleration torque. First, the ratio change alone increases the deceleration due to torque multiplication. Second, the shift towards underdrive also drives engine speed higher which moves the operating point on the engine braking torque map (depicted in FIG. 5) and thereby increases the available negative engine torque. The engine braking request depicted in FIG. 6 represents the relative request (0−1) of the maximum available at the given operating conditions. A combination of CVP ratio, engine throttle servo, and gearbox mode is used to satisfy the request.

Turning not to FIG. 7, in some embodiments, an onboard accelerometer is used to detect the presence of a road grade. The accelerometer may be a dedicated sensor wired directly to the transmission control module (TCM) 104 or may be an existing device already in use for the vehicle stability control system. Grade information would be then received by the TCM 104 over the existing module to module communications network (CAN, Flexray, etc.). The detection of a downhill grade would indicate the need for increased engine braking which is accomplished with a CVP ratio command biased towards underdrive. The detection of an uphill grade would indicate the need for increased tractive effort which is also accomplished with a CVP ratio command biased towards underdrive. The engine braking depicted in FIG. 6 represents the relative request (0−1) of the maximum available at the given operating conditions. A combination of CVP ratio, engine throttle servo, and gearbox mode is used to satisfy the request. For vehicle with integrated navigation systems the GPS information can be used to drive an active control without driver intervention. When the GPS data indicates the presence of a downhill grade, the control system automatically alters throttle servo, biases the CVP ratio command towards underdrive, or downshifts range box to provide increased engine braking similar to FIG. 6.

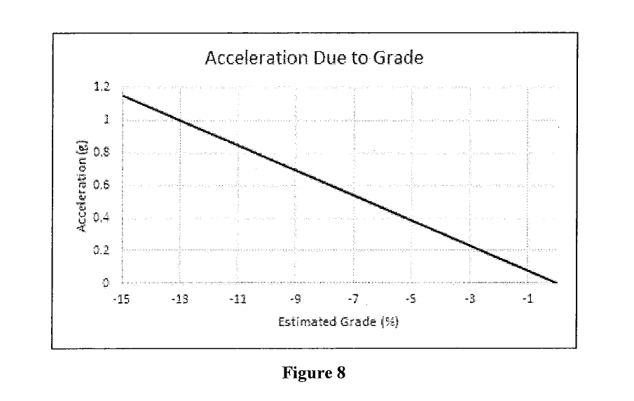

Referring now to FIG. 8, in some embodiments, a software model of expected vehicle acceleration for given operating conditions can be developed. Current vehicle acceleration is compared to the model. If the comparison is negative (expected minus actual), then the presence of a downhill grade can be inferred. Tractive effort (Ftractive_effort) delivered by the powertrain is estimated from current parameters. Road load forces (“Froad_load”) are modeled by the following equations, where “mass_vehicle” is the mass of the vehicle, and “a_vehicle” is the acceleration of the vehicle.

$${F}_{tractive \_ effor t} - \sum {F}_{road \_ load} = {mass}_{vehicle} * {a}_{vehicle}$$

Taking the temporary assumption that the vehicle is on level ground the road load forces are comprised of aerodynamic force (Faero), rolling resistance forces “Frolling_resistance”, and inertial forces (Finertial):

F_{road}_{_}_{load}=Fₐₑᵣₒ+F_{rolling}_{_}_{resistance}+Fᵢₙₑᵣₜᵢₐₗ

Combining the information above, the modeled vehicle acceleration is calculated. Vehicle speed data is used to calculate the actual acceleration (a_actual) and error (a_error) from the model (a_model).

aₑᵣᵣₒᵣ=a_{model}−a_{actual}

Next, the assumption is made that the acceleration error is due to road grade. Road grade resistance (F_grade) and the acceleration due to grade are as follows.

F_{grade}=mg*sin θ

F_{grade}=m*aₑᵣᵣₒᵣ

Setting both equations equal to each other, mass cancels as expected, and solving for theta yields the following,

$$θ = {sin}^{- 1} ( \frac{{a}_{error}}{g} )$$

The θ value found can be converted to an estimated grade % and then used to drive an engine braking control similar to FIG. 6. Vehicle acceleration potential due to grade is depicted in FIG. 7.

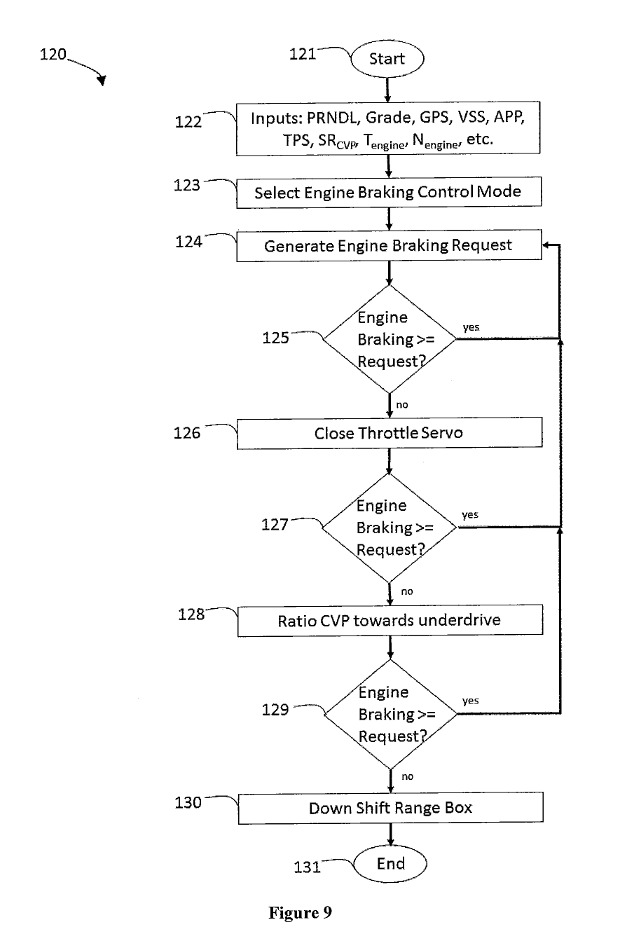

Referring now to FIG. 9, in some embodiments, an engine braking control process 120 is implementable in the transmission control module 104. The engine braking control process 120 begins at a start state 121 and proceeds to a block 122 where a number of signals are received, for example, from the input sensor processing module 102. In some embodiments, the input signals include a PRNDL signal indicative a gear shift position, a grade signal, a GPS signal, a vehicle speed signal, an accelerator pedal position signal, a throttle position signal, a CVP speed ratio signal, an engine torque signal, an engine speed signal, among others. In some embodiments, a grade signal is provided by a hardwired sensor or a virtual sensor. The engine braking control process 120 proceeds to a block 123 where an engine braking control mode is selected based on the input signals received in the block 122. The engine braking control process 120 proceeds to a block 124 where an engine braking request is generated. For illustrative example of methods of generating engine braking requests, refer to FIGS. 5-7 and supporting description. The engine braking control process 120 proceeds to a first evaluation block 125 where the engine braking request generated in the block 124 is compared to a calibrateable threshold. If the engine braking request is above the calibrateable threshold, the first evaluation block 125 returns a true value and the engine braking control process 120 returns to the block 124. If the engine braking request is below the calibrateable threshold, the first evaluation block 125 returns a false value and the engine braking control process 120 proceeds to a block 126 where a command is send to close the throttle servo. In some embodiments, the closing of the throttle servo corresponds to a lowering of the engine speed and torque. The engine control process 120 proceeds to a second evaluation block 127 where the engine braking request generated in the block 124 is compared to the calibrateable threshold. If the engine braking request is above the calibrateable threshold, the second evaluation block 127 returns a true value and the engine braking control process 120 returns to the block 124. If the engine braking request is below the calibrateable threshold, the second evaluation block 127 returns a false value and the engine braking control process 120 proceeds to a block 128 where a command is sent to adjust a CVP speed ratio towards an underdrive condition. The engine control process 120 proceeds to a third evaluation block 129 where the engine braking request generated in the block 124 is compared to the calibrateable threshold. If the engine braking request is above the calibrateable threshold, the third evaluation block 129 returns a true value and the engine braking control process 120 returns to the block 124. If the engine braking request is below the calibrateable threshold, the third evaluation block 129 returns a false value and the engine braking control process 120 proceeds to a block 130 where a command is sent to downshift a multiple speed range box coupled to the CVP. The engine braking control process 120 ends at a state 131. In some embodiments, the engine braking control process 120 is optionally configured to return to the block 122 from the block 130.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein can be employed in practicing the preferred embodiments. It is intended that the following claims define the scope of the preferred embodiments and that methods and structures within the scope of these claims and their equivalents be covered thereby.

What is claimed is:

1. A method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method comprising the steps of:
receiving a plurality of input signals indicative of a PRNDL gear position, a vehicle speed, and a CVP speed ratio;
evaluating an engine braking condition based on the PRNDL gear position;
determining an engine braking request based on the vehicle speed;
comparing the engine braking request to an engine braking threshold;
determining a CVP speed ratio setpoint based on the comparison of the engine braking request to the engine braking threshold; and
issuing a commanded CVP speed ratio to impart a change in the operating condition of the CVP.

2. The method of claim 1, wherein issuing the commanded CVP speed ratio further comprises shifting the CVP to an underdrive condition.

3. The method of claim 1, wherein determining the engine braking request further comprises generating a calibration table containing values of the engine braking request as a function of vehicle speed.

4. A method for controlling a continuously variable transmission having a ball-planetary variator (CVP) provided with a ball in contact with a first traction ring assembly, a second traction ring assembly, and an idler assembly, wherein the continuously variable transmission is operably coupled to an engine, the method comprising the steps of:
receiving a plurality of input signals indicative of a grade, a vehicle speed, and a CVP speed ratio;
evaluating an engine braking condition based on the grade;
determining ab engine braking request based on the vehicle speed;
comparing the engine braking request to an engine braking threshold;
determining a CVP speed ratio setpoint based on the comparison of the engine braking request to the engine braking threshold; and
issuing a commanded CVP speed ratio to impart a change in the operating condition of the CVP.

5. The method of claim 4, wherein issuing the commanded CVP speed ratio further comprises shifting the CVP to an underdrive condition.

6. The method of claim 5, wherein determining an engine braking request further comprises generating a calibration table containing values of the engine braking request as a function of road grade.

7. A method for controlling a continuously variable transmission having a ball-planetary variator (CVP) provided with a ball in contact with a first traction ring assembly, a second traction ring assembly, an idler assembly, wherein the continuously variable transmission is operably coupled to an engine, the method comprising the steps of:
receiving a plurality of input signals indicative of a vehicle speed and a CVP speed ratio;
evaluating an engine braking condition based on the vehicle speed;
determining a engine braking request based on the vehicle speed;
comparing the engine braking request to an engine braking threshold;
determining a CVP speed ratio setpoint based on the comparison of the engine braking request to the engine braking threshold; and
issuing a commanded CVP speed ratio to impart a change in the operating condition of the CVP.

8. The method of claim 7, wherein issuing the commanded CVP speed ratio further comprises shifting the CVP to an underdrive condition.

9. The method of claim 8, wherein determining the engine braking request further comprises estimating a road grade based on an acceleration of the vehicle.

10. The method of claim 9, wherein the acceleration of the vehicle is based on the vehicle speed.
